(19) United States
(12) Patent Application Publication
(10) Pub. No.: US 2005/0178824 A1
(43) Pub. Date: Aug. 18, 2005

(54) ON-LINE MERCHANT SERVICES SYSTEM AND METHOD FOR FACILITATING RESOLUTION OF POST TRANSACTION DISPUTES

(75) Inventors: Blake Benson, Phoenix, AZ (US); Naveen Jaiswal, Scottsdale, AZ (US); Dean Kerl, Gilbert, AZ (US); Sukumar Rajagopalan, Phoenix, AZ (US); Judith Continelli, Glendale, AZ (US); Sandy Hazeltine, Phoenix, AZ (US)

Correspondence Address: SNELL & WILMER;ONE ARIZONA CENTER, 400 EAST VAN BUREN, PHOENIX, AZ, 850040001, US

(73) Assignee: AMERICAN EXPRESS TRAVEL RELATED SERVICES COMPANY, INC., New York, NY (US)

(21) Appl. No.: 10/711,388

(22) Filed: Sep. 15, 2004

Related U.S. Application Data
(63) Continuation-in-part of application No. 09/537,506, filed on Mar. 29, 2000.
(63) Continuation-in-part of application No. 10/391,492, filed on Mar. 18, 2003.

(51) Int. Cl. G06K 5/00; G06F 17/60

(52) U.S. Cl. 235/380; 705/39

(57) ABSTRACT

A system is disclosed for facilitating the handling of post transactional credit disputes in real-time via a variety of transactional environments and architectures. The system includes one or more workstations linked to a communication channel and one or more servers with at least one having capability of processing a plurality of image files. A party in dispute (such as a merchant) may browse their workstation for image files, choose the appropriate image files, and transmit the image files over the communication channel to a server for processing.

### CROSS-REFERENCE TO RELATED APPLICATIONS

The present application is a continuation-in-part of, and claims priority to, and the benefit of, U.S. Non-Provisional patent application Ser. No. 09/537,506 entitled “System And Method For Facilitating The Handling Of A Dispute” filed Mar. 29, 2000, and U.S. Non-Provisional patent application Ser. No. 10/391,492 entitled “System And Method For Facilitating The Handling Of A Dispute Using Disparate Architectures” filed Mar. 18, 2003, the entire contents of which are hereby incorporated by reference in their entirety.

### FIELD OF INVENTION

The invention generally relates to handling disputes, and more particularly, to an online, real-time dispute processing system and method for resolving post transactional credit disputes in a variety of transactional environments and architectures.

### BACKGROUND OF INVENTION

Consumers worldwide are increasingly purchasing goods and services on credit. For many purchasers, the most convenient form of payment is a plastic card with a magnetic stripe, an embossed account number and/or a smart chip called a credit card (“card” or “cards”). Cards may be used at service establishments (e.g., automated teller machines (ATM), point of sale (POS), and instances when no card is used during the transaction such as purchases over the Internet), wherein merchants have entered into agreements with an Acquirer for the merchant to accept cards from cardmembers to charge purchases of goods and services or for cash access. An Acquirer may be, for example, a non-financial or financial entity that specializes in the marketing, installation and support of POS card acceptance at merchants. Acquirers generally negotiate a contract with the merchant to accept a brand of cards (e.g., AMERICAN EXPRESS®, VISA®, MasterCard®, DISCOVER CARD®).

Card Issuers are typically banks and other financial organizations (e.g., Bank of America®, Citibank®, MBNA America®, Chase Manhattan Bank®) operating under the regulations of a card issuing association or entity. The cardmember enters into an agreement and establishes a card account with the Issuer. The Issuer's name generally appears on the card and cardmember's payments are typically sent to that Issuer.

Occasionally, cardmembers may receive unsatisfactory goods or services from the merchant, be involved with a dispute over price with the merchant, or the merchant may have failed to comply with the regulations and/or terms of its card acceptance agreement with the Acquirer. Typically the cardmember then notifies the Issuer about the dispute with the merchant, which prompts the Issuer to notify the Acquirer that the cardmember has a dispute with the merchant. After an investigation by the Acquirer, the Acquirer will notify the merchant and initiate a dispute resolution process between the merchant and the Acquirer. Alternatively, the Issuer may begin the dispute process in the absence of any cardmember complaint, for example when the merchant fails to comply with regulations and/or terms.

In order to substantiate the dispute claim, the Acquirer may first request documents from the merchant such as a receipt. The receipt for a cardmember's purchase or credit transaction containing the details of any transaction carried out with the merchant is called the record of charge (ROC). A retrieval request may include a request for either an original ROC, a legible reproduction of the ROC, or any other transactional documentation from the merchant. A typical “chargeback” is a reversal of a credit transaction which is “charged-back” to the merchant from the Acquirer. The merchant may refute the chargeback and process a “second presentment” to the Acquirer with additional documentation. A “final chargeback” by the Acquirer to the merchant occurs if the Acquirer refutes the “second presentment”.

The aforementioned dispute handling process between cardmembers, Issuers, Acquirers and/or merchants is largely a manual documentation gathering process. Each step, beginning with the retrieval request, includes copying, mailing or faxing documentation. The entire manual process may consume valuable employee time and resources. Furthermore, while the dispute is being settled, the charge remains pending on either the cardmember's account or on un-reconciled billings. Communication between the parties (i.e., cardmember, Issuer, Acquirer, merchant) is on-going until the dispute is settled. In the above-described known dispute processes involving non-electronic transmission of documentation, communication may only occur during normal business hours. This can be difficult due to varying time zones.

Thus, there exists a need for streamlining post-transactional credit disputes by providing electronic transmission of documentation. Accordingly, there exists a need for a credit dispute system and method that increases the efficiency of the process. More particularly, there is a need for a system and method of processing a credit dispute that allows an initiator (such as an Acquirer) to begin a dispute process by, for example, initiating an Inquiry request to a responder (such as a merchant), then allowing the responder to fulfill the request in an online, real-time processing environment.

Moreover, data interchange between parties can be problematic if the interchange is between disparate users and systems. For example, each party (e.g., merchant and Acquirer) may have their own systems infrastructure which may include, for example, their own servers respectively. Alternatively, a central server may be used, but the process of multiple parties accessing the server from their own infrastructures may be inefficient, costly and/or complicated. Thus, there exists a need for a credit dispute system and method that provides a well-defined and adaptable data interchange format to facilitate communication with multiple parties, and their respective system infrastructures with minimal error.

### SUMMARY OF INVENTION

The present invention overcomes the problems outlined above and provides an improved system and method for facilitating, processing and retrieving documentation for the handling of a post-credit dispute between an initiator and a responder.

In an exemplary embodiment of the invention, the system includes a workstation capable of receiving commands from a user in response to an Inquiry associated with the post-transactional credit dispute; a server in communication with said workstation; a storage connected to said workstation, said storage having a plurality of documentation files stored thereon, said files having content that is relevant to the post-transactional credit dispute, said files capable of being transmitted from said workstation to said server; a first communication channel coupling said workstation and said server; a backend processing computer in communication with said server, wherein said backend processing computer is configured to process said transmitted documentation files; and a second communication channel coupling said server and said backend processing computer, wherein said second communication channel is configured to transmit said documentation files from said server to said backend processing computer.

An exemplary method of the invention, executed in a computer network for facilitating handling of documentation for a post-transactional dispute, includes accepting, at said server, a User ID and password from a user at the terminal; displaying an Inquiry at the terminal, wherein said Inquiry is associated with said post-transactional dispute and said user is a party to said post-transactional dispute; locating said documentation associated with said Inquiry; transmitting said located documentation to said server; confirming receipt of said documentation at said server; associating said transmitted documentation with said post-transactional dispute; and storing said transmitted documentation and said association data for later retrieval.

### BRIEF DESCRIPTION OF DRAWINGS

These and other features, aspects and advantages of invention may be best understood by reference to the following description taken in conjunction with the accompanying drawings in which like numerals represent like elements:

FIG. 1A illustrates an on-line merchant services system in accordance with an exemplary embodiment of the present invention;

FIG. 1 B illustrates an on-line merchant services system in accordance with an alternative embodiment of the present invention;

FIG. 2 illustrates an exemplary flow chart for steps for accessing the system in accordance with an embodiment of the present invention;

FIG. 3 illustrates a flow chart for a merchant to provide a response in accordance with an embodiment of the present invention; and

FIG. 4 illustrates a flow chart for the steps to process an image file in accordance with an embodiment of the present invention.

### DETAILED DESCRIPTION

In general, the present invention uniquely facilitates the handling of post transaction disputes with merchants. Specifically, the system and methods described herein allow a merchant to handle a post transaction in a real time manner by utilizing the on-line system of the present invention. Among other features, the merchant may browse their computer network for documentation relevant to a post transaction dispute, upload the relevant documentation to the on-line system, and associate the documentation with the ongoing dispute. The on-line system may also, for example, confirm the integrity of the uploaded documentation, scan the uploaded documentation for viruses, and further process the uploaded documentation in order to facilitate handling the post transaction dispute.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, (e.g., memory elements), processing elements, logic elements, look-up tables, and the like, which may carry out a variety of functions under the control of one or more microprocessors or other control devices. Similarly, the software elements of the present invention may be implemented with any programming or scripting language including, but not limited to, C, C++, Java, COBOL, assembler, PERL, extensible markup language (XML), and Microsoft's Visual Studio NET, with the various algorithms being implemented with any combination of data structures, objects, processes, routines or other programming elements. Further, it should be noted that the present invention might employ any number of conventional techniques for data transmission, signaling, data processing, network control, and the like. For a basic introduction of cryptography and network security, the following may be helpful references: (1) “Applied Cryptography: Protocols, Algorithms, And Source Code In C,” by Bruce Schneier, published by john Wiley & Sons (second edition, 1996); (2) “Java Cryptography,” by Jonathan Knudson, published by O'Reilly & Associates (1998); (3) “Cryptography & Network Security: Principles & Practice,” by William Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development, database operations, and other functional aspects of the system (and components of the individual operating components of the systems) and method may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, and/or a collection of one or more computer program products. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

As stated above, the present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The Acquirer, as used herein, may include any entity, software or hardware that markets, installs, and/or supports POS transaction card acceptance at merchants, and typically negotiates a contract with the merchant to accept certain brands of cards.

A Card, as used herein, may include any transaction instrument such as a charge card, credit card, debit card, awards card, prepaid card, telephone card, smart card, magnetic stripe card, bar code card, transponder, radio frequency card and/or the like associated with an account number, which cardholders typically present to merchants, as part of a transaction, such as a purchase. An “account number”, as used herein, includes any device, code, number, letter, symbol, digital certificate, smart chip, digital signal, analog signal, biometric or other identifier/indicia suitably configured to allow the consumer to interact or communicate with the system, such as, for example, authorization/access code, personal identification number (PIN), Internet code, other identification code, and/or the like which is optionally located on card. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format will generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer.

A Cardmember, as used herein, may include any entity, software or hardware, typically an individual person or corporation that has been issued a card or is authorized to use a card (also known as a cardholder”).

An Inquiry or Inquiry Request, as used herein, may include a request from an Acquirer to a merchant that requests information and possibly documents with respect to a Dispute Claim made by a cardmember. An Inquiry may also be submitted in the absence of a dispute claim if an Acquirer, as opposed to the cardmember, identifies a transaction that it wishes to dispute.

A Merchant Response, as used herein, may include a response from a merchant to an Acquirer which supplies information and possibly documents with respect to a Dispute Claim.

A Chargeback, as used herein, may include a reversal of a credit transaction which is “charged-back” to the merchant from the Acquirer. The chargeback typically results in the actual transfer of funds between merchant and Acquirer and may be a manual or automated process. Additional chargebacks may take place between the Issuer and Acquirer, and between the cardmember and Issuer. Several possible chargebacks may be depicted in the Figures, however these are for general illustration of probable adjustments and not all chargebacks shown would typically occur.

A Dispute Claim, as used herein, may include any request that may initiate a dispute resolution process (e.g., from a cardmember to an Issuer; from an Issuer to an Acquirer; from an Acquirer to a merchant). A dispute claim may include information about a disputed charge as might occur when a cardmember receives unsatisfactory goods or services, or where the merchant failed to comply with regulations and/or terms of the card acceptance agreement with the Acquirer. For example, a cardmember may initiate a dispute claim by a phone call or online correspondence with a customer service representative of the Issuer agency. However, before a dispute claim is resolved, the merchant may need to provide information in writing and may also provide supporting documentation such as the merchant copy of the receipt of charge (ROC).

An Issuer, as used herein, may include any bank or other financial institution or any hardware or software typically operating under regulations of a card issuing association or entity and which issues cards to cardmembers under a cardmember agreement for a cardmember account.

A Receipt of Charge, as used herein, may include a document generated when a merchant executes a transaction with a cardmember. It is often signed by the customer, and a copy is often retained by both customer and merchant.

A merchant, as used herein, may include any entity, individual, organization, software and/or hardware that supports a transaction using a card or information derived from a card. Merchants may include automated teller machines (ATMs), Point of Sale (POS) devices, retailers, etc. that are bound to agreements with Acquirers to accept cards from cardmembers to charge purchases of goods and services or for cash access.

The present invention relates to an improved system and method for facilitating the handling of credit disputes using a real-time dispute processing system. Although the system may be suitable for a variety of dispute processing applications, (e.g., customer billing disputes, disputes including the exchange of information between customers and vendors or creditors) the present invention is conveniently described with reference to the credit disputes between Acquirers and merchants.

The subject matter of the present invention is particularly suited for use in connection with post transactional credit disputes between Issuers, Acquirers, cardmembers and merchants. As a result, an exemplary embodiment of the present invention is described in that context. It should be recognized, however, that such description is not intended as a limitation on the use or applicability of the present invention, but instead is provided merely to enable a full and complete description of an exemplary embodiment.

The various embodiments of the invention may be adapted to any number of systems architectures and environments. For instance, depending on the particular systems of the parties participating in the dispute resolution transaction, the systems and methods of the invention can be varied to accommodate data interchange between the parties. Described herein are an exemplary system architecture and its various embodiments. It should be appreciated that the systems and methods disclosed in the description and by the flowcharts are equally adaptable to various other architectures.

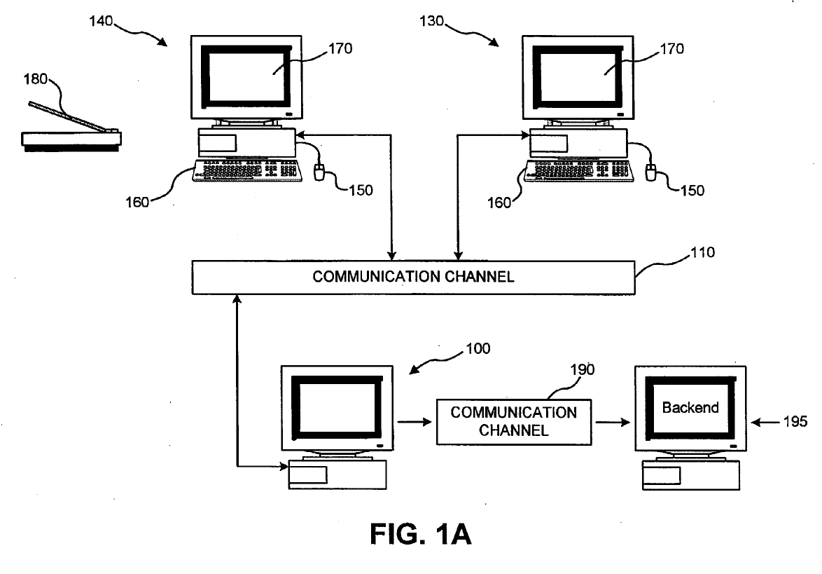

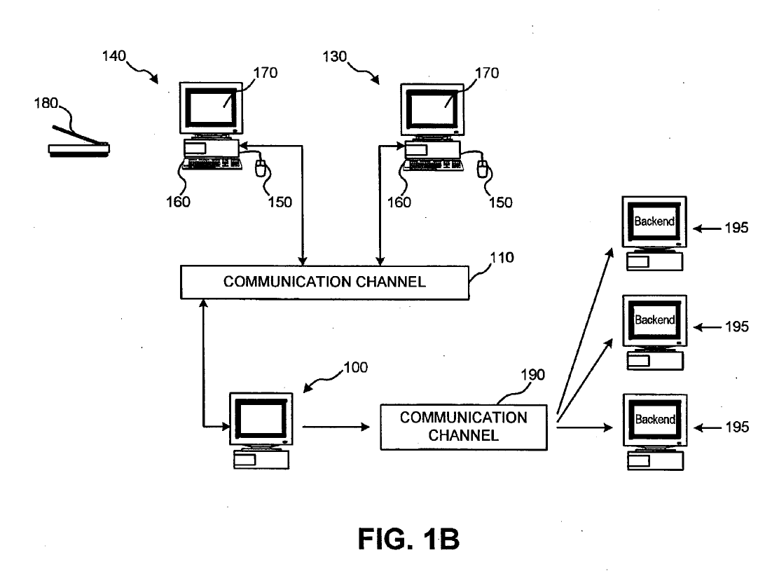

In an exemplary embodiment, the Internet-based processing system of the present invention is illustrated in FIG. 1A. One skilled in the art will appreciate that the system may also operate on an intranet, extranet, LAN, WAN, satellite or any other network or with any other device for use on a communication system, such as a personal digital assistant (PDA), smart phone, cellular phone or any other suitable communication device.

The architecture embodied in FIG. 1A illustrates and describes a central server 100 having a website and/or Internet capabilities. Computer interfaces may be used to retrieve suitable documentation in a purely electronic form, such as an existing scan of the ROC or an electronic facsimile of the ROC, as might be generated by a merchant's point of sale device or by an all-electronic transaction that occurs on the Internet.

A central server 100 having web site information and web page applications stored thereon is linked to a communication channel 110. Central server 100 maintains an operating computer program for the web site. The computer may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, InterBase, etc., may be used to provide an ADO-compliant database management system. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

Central server 100 may include one or more databases of any type, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is the same in one embodiment. However, data tables having similar, though not identical, data in the key fields may also be merged by using AGREP, for example.

Communication channel 110 facilitates communication between the parties to the transaction and the system of the present invention. Channel 110 may be any suitable communication means for exchanging data or transacting business, such as, a telephone network, Intranet, Internet, extranet, WAN, LAN, satellite communications, point of interaction device (point of sale device, personal digital assistant, cellular phone, kiosk, etc.), online communications, off-line communications, wireless communications, transponder communications and/or the like. It is noted that the channel may be implemented as other types of networks, such as an interactive television (ITV) network.

Exemplary internet or intranet (depending on the user access channel) capable terminals 130 and 140 are provided for end-users to access the web site via communication channel 110. User computer can be in a home or business environment with access to a network. In an exemplary embodiment, access is through the Internet through a commercially-available web-browser software package. Each terminal 130 and 140 is, in one embodiment, equipped with a display 170 and an input means. As an example, display 170 may be a terminal screen or any other suitable display. Data is entered by the user with any known data input means. As shown, terminals 130 and 140 are equipped with a point and click input means (e.g., a mouse) 150 and a keyboard input means 160. Input means 150 and 160 are merely an example and not intended to limit the scope of the invention, for example, voice recognition, touch screen methods, kiosk, personal digital assistant, handheld computers (e.g., Palm Pilot®), cellular phones, and/or the like, are also available. Terminals 130 and 140 include, in one embodiment, personal computers including but not limited to, a PENTIUM® PC, and include a minimum of 32 MB RAM, a 28.8 baud rate modem or company LAN (local area network) access, and 400 MB of available disk space on a local hard drive or network. Terminals 130 and 140 may include a compression software such as WINZIP® 7.0 or greater, an operating program such as WINDOWS 95/98/2000®, WINDOWS NT®, Linux, Solaris, etc, an application such as WINDOWS EXPLORER® 4.0 with update version Service Pack 1 or greater, or NETSCAPE NAVIGATOR® version 4.07 or greater, as well as various conventional support software and drivers typically associated with computers. In addition, terminals 130 and 140 may include a machine that does not require human interaction.

Additionally, the system may include a document scanning device 180. As illustrated in FIG. 1A, terminal 140 may be coupled to a scanning device 180. Terminal 130 or other components may also be coupled to a similar scanning device. Scanning device 180 may have a resolution of at least 600 dpi. Supporting documentation is suitably transformed into computer readable format by scanning device 180. For example, an end-user operating scanning device 180 may scan receipts, rental agreements, hotel folios and the like, and then store the scanned data on the hard drive of terminal 140. Such supporting documentation can then be transmitted to server 100. In one embodiment, the user's system includes a scanner and TWAIN driver. When the user accesses a form that supports attachment of a scanned image, the user action invokes an active client component in the form of a Java component or ActiveX control, downloading it first if necessary (e.g., click on a button and cause an HTTP POST).

The system further comprises an Event Message and Imaging (EMI) communication channel 190 that communicates with server 100. Communication channel 190 comprises any communication channel or computer that is capable of transmitting the received documentation to a backend processing computer 195 for further processing as described below. For example, the received documentation may be combined into a single zipped file for transmission to backend processing computer 195. Communication channel 190 may utilize any well-known communication protocol such as Message Queue (MQ), file transfer protocol (FTP), sockets, and the like. In accordance with an alternative embodiment, as illustrated in FIG. 1B, a plurality of backend processing computers 195 may be utilized to perform processing of the images. One skilled in the art can appreciate that an alternative embodiment may include a desktop application to perform the described image viewing and processing performed by backend processing computer 195.

An exemplary method of the present invention may be executed in a network computer system with a computer program that controls the operation of terminals 130, 140, server 100 and/or backend processing computer 195. The computer program may be suitably stored on server 100 or any of the other computers located in the network by methods common to one skilled in the art, such as, for example, in the read-only-memory (ROM) or the hard drive memory of server 100. An exemplary network computer system used for the method of the present invention is illustrated as FIG. 1A.

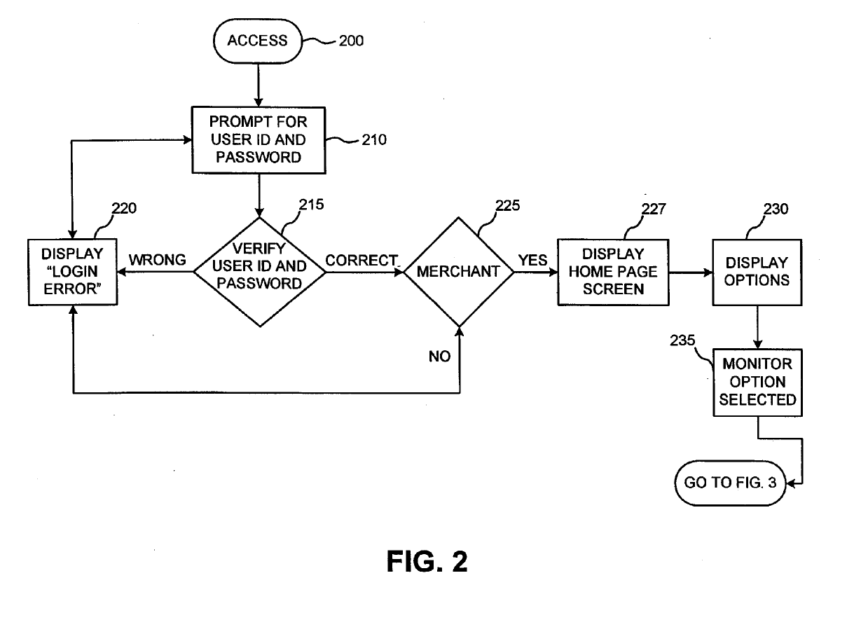

With reference to FIG. 2, the steps performed by the computer program while executing one exemplary method of the present invention are illustrated. These steps are merely illustrative and certain steps may be modified or eliminated. The user (e.g., merchant, Issuer, Acquirer, administrative and financial personnel, cardmember) completes a User ID request and receives a User ID and password. User IDs and passwords may be unique to specific users and are stored on the server database.

An end-user, for example a merchant, accesses the web site (step 200) by any known Internet browser means such as MICROSOFT INTERNET EXPLORER® or NETSCAPE NAVIGATOR®. The user may go through an authentication process such as entering an ID and password (step 210). As previously discussed, the user may be a person, such as a merchant, or a computer host or system, such as Acquirer infrastructure or Issuer infrastructure. The mechanism for authentication defines a variant, for which there are generally many alternatives. For instance, the process of authentication may include receiving and processing credentials, which is the information the receiving system uses to confirm the identity of the user. The user ID and password are credentials. Although credentials in general may include many different forms, three basic categories of credentials may include, (1) who you are; (2) what you have; and (3) what you know. The first category, “who you are”, equates to biometrics, and can be described as any characteristic intrinsic to the physical manifestation of the user. Examples are fingerprints, retinal patterns, and DNA. The second category, “what you have”, includes, for example, systems the user is physically in possession of. In such systems, the credential the user possesses generally interfaces with the authentication systems. Alternatively, the user may mediate the interface to the system, as occurs when the user keys in digits that are displayed on a security token device. Examples of suitable second category systems include an X.509 digital certificate (e.g., stored in a certificate store on a workstation), smart card, Fortezza® card, etc. The third category, “what you know”, may include a password, passphrase, identification number such as social security number, answer to a question such as what is your pet's name, etc. Variation in authentication includes the above as well as various other types of credentials known or to be discovered by those skilled in the art.

The authentication variant may be further defined by means of entry. Point of entry variation is typically seen at the point in processing where the user initially provides credentials. For instance, variation may occur in the types and implementations of the user's devices and in the communication form the user's systems to other systems. For biometrics, there are many possible types of interface devices, and these devices will employ communication to the underlying workstation or host. In an exemplary embodiment based on biometrics, the biometric interface device (for example, a retinal scanner) employs a secure protocol and possibly asymmetric key cryptography. Such processing provides the retinal scan data to the receiving systems in a way that does not compromise privacy or integrity, but is resistant to replay attacks that allow eavesdropping devices to monitor and record the communication between the biometric interface device and the connected machine for later replay.

Considerable variation is possible for X.509 certificates, which might be stored on a smart card, user workstation, or other device. A system based on certificates typically includes a mechanism for the user to “unlock” the key store that contains the certificate to be used. Some smart card readers include a keypad for entering of a personal identification number that unlocks the key stored on the smart card device. Many key stores include password protection, wherein a user enters a password before releasing certificates. Most HTTP web browsers include a X.509 key store that can be used to store X.509 certificates that can be exchanged with a web server during client certificate authentication process that can be part of HTTP communications based on the Secure Sockets Layer (SSL) protocol version 3.

Point of entry variation also may also occur in the presentment of the third category of credentials, “what a user knows.” For example, when a user enters a password, it may be passed directly to the receiving system. In one embodiment, the password is protected by means of processing known as a “one way hash”, as is used in the UNIX operating system. In this embodiment, when the user ID and password are matched with a database on the authenticating system, the hashed password is matched as opposed to the plaintext password. Entry of the credential may also include a variety of mechanisms, such as a WINDOWS security dialog, as would be seen with Microsoft Internet Explorer, and a web form as may be presented by a web browser such as Microsoft Internet Explorer or Netscape Navigator.

Other stages in processing may include the transfer of credentials to an authentication system, and the subsequent processing by that system. Authentication systems themselves may be embodied by machines that are distinct from the machines depicted in the architectures of this invention. For example, under Microsoft Windows authentication, a Domain Server or Active Directory Server houses the authentication system and performs authentication on behalf of other machines that authenticate users, such as a web server acting as an Acquirer Host. Alternatively, an authentication system may reside on the same machines that include authentication.

The exact processing by the authentication system may also depend on point of entry processing as well as other factors. One mechanism that may be used to securely transmit credentials is SSL, in which case both the workstation at which the user enters credentials and the server with which the user interacts performs processing in accord with the SSL protocol.

With continued reference to FIG. 2, after accessing the web site, the program stored on server 100 may be configured to prompt the end-user for a User ID and password (step 210). The User ID and password are verified (step 215) and if they do not correspond to a known (stored) and valid User ID and password, the program displays a “Logon Error” message (220) and returns to the previous screen (step 210).

Once the merchant, or any user, has been authenticated by matching the entered User ID and password with a database located on the server, the merchant may be presented (or authorized) with only those functions the merchant is authorized to use. “Authorization” is a mechanism that determines what kinds of actions a user is permitted to take, based upon their security realm or identity that was established during authentication. “Workflow” is the possible actions presented to a user in interacting with a system. In one embodiment, the identity of the user is established during authentication and the systems determine whether the merchant is an authorized merchant or a user of the system. If they are an authorized merchant, then the workflow of the system may automatically direct them to user interface elements that are useful to a merchant, such as forms for reviewing inquiries, filling out merchant requests, reviewing chargebacks, creating supplemental merchant requests, and reviewing final chargebacks. If a user were to attempt to access screens for a different type of user, authorization denies access to those screens. Authorization and workflow can be implemented in many different ways using standard tools and methodologies such as HTML coding and server side scripting with Application Server Pages (ASPs) and .NET components under Microsoft Internet Information Server (IIS) or else using HTML coding, Java Server Pages (JSP), and Java Servlets, with a web server that handles Java servlets and JSPs.

The invention is configured to respond to the entry of the User ID and password with a set of queries to determine what type of user has been verified (e.g., merchant, Acquirer, Issuer). If the entered User ID and password correspond to a merchant (step 225), the program causes the “home page” to display (step 227). In general, “home page” is a term used in the industry to indicate a main or central screen from which the user can select options. One skilled in the art will recognize that “home page” options may be included throughout a routine or sub-routine to allow the user to return to the main or central screen at any time and start over with another routine. From the home page, the merchant chooses the option to begin a dispute handling process and the program causes the computer terminal 130 or 140 to display various options for locating and supplying information associated with a particular dispute (step 230).

Upon display of the “Options” screen for the merchant, the program monitors the response of the user for one of the options presented on the display (step 235). In an exemplary embodiment, the program causes a display which allows the user to choose and respond to various Inquiries for post transaction disputes.

In practice, the Issuer may be notified by a cardmember that there is an unresolved dispute with a merchant. For example, the cardmember may have received unsatisfactory goods or services or there may be a discrepancy in the price paid. The Issuer then begins the dispute handling process with the Acquirer on behalf of the cardmember. In accordance with one aspect of the present embodiment, the dispute handling process may begin automatically, without human intervention, upon receipt of notification from the cardmember. The cardmember may provide notification in a variety of ways, including e-mail, telephone, voicemail, and written correspondence. Once the Acquirer confirms the dispute with the Issuer, the Acquirer may initiate an Inquiry with a merchant.

In various embodiments of the systems and methods described, there may be included one or more rules engines capable of automating some of the processes without human interaction. These systems components may be configured to perform such functions as letter generation, email generation, and other messaging to notify a human that some sort of interaction is desired. The result of such automation may be the termination or elimination of some of the process steps. For example, identification of duplicate transactions within the infrastructure may lead directly to a chargeback without requiring a merchant response from the merchant. It should be recognized that the various steps illustrated in the Figures and the accompanying descriptions reflect the possibility of automated processing.

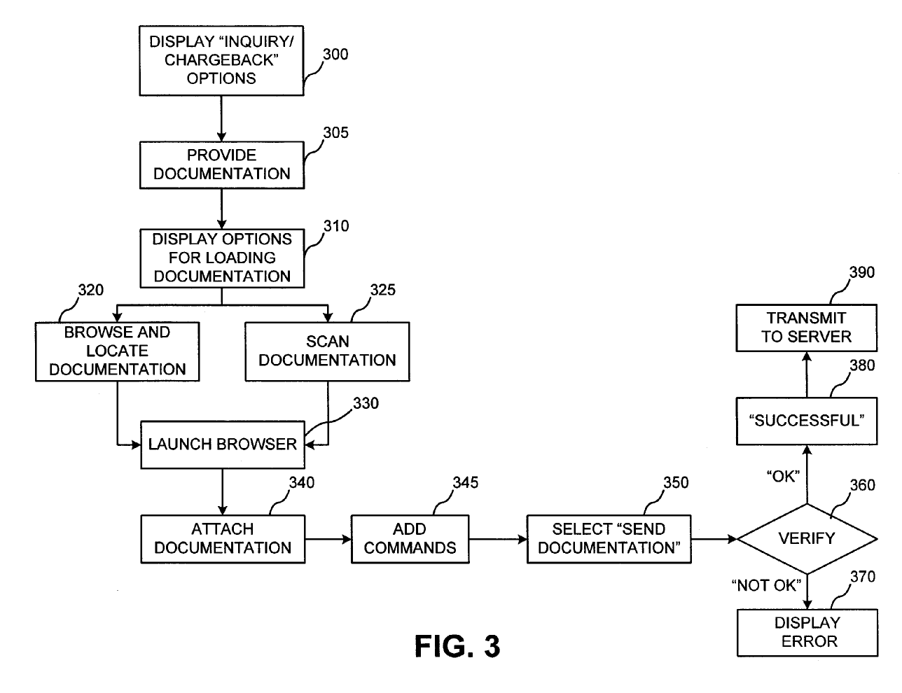

Referring to FIG. 3, upon selection of “Merchant Response,” the invention causes the end-user computer to display a form with options for responding to an Inquiry or to a Chargeback (step 300). In general, the form is a means for the merchant to provide the requested information or documentation back to the Acquirer. Throughout the form, the program prompts the merchant to enter data with respect to the unresolved dispute. The merchant is asked to provide information which will help the Acquirer to resolve the disputed matter and to promote a fast response time. The requested data can vary according to the dispute application, however, for the sake of brevity, the present invention is described with respect to one exemplary application for merchants. The merchant may be asked to provide documentation that is relevant to the dispute (step 305). Documentation that may be provided includes merchant receipts, description of goods/services sold (including quantity), amount of transaction, and the like.

If the merchant is requested to provide documentation, the invention causes a display of various options to be shown for locating and providing documentation for a particular dispute (step 310). A drop-down menu may be used by the merchant to browse their computer system and locate documentation (e.g., images of receipts) that may be attached to an Inquiry and submitted for processing (step 320). In accordance with one aspect of the present invention, the documentation may include TIFF files, JPEG files, PDF files, or any other well-known image file format. The merchant may store documentation on their computer system in a variety of ways. For example, the merchant may store documentation by transaction date. That is, each day may have its own folder for storing documentation. Alternatively, the merchant may store documentation by transaction type, such as by type of goods sold or by services provided. Other methods of organizing documentation may include organizing documentation by customer name or by customer location. In addition, the merchant may scan in receipts or other documentation. Scanning may be facilitated by using the document scanning device 180 (step 325). Referring back to FIG. 1, terminal 140 may be suitably coupled to a document scanning device 180 or terminal 140 may transmit or supply information to a third party for scanning or input. The end-user merchant may operate scanning device 180 to transform any supporting documentation into computer readable format. Typically, the scanned image may be transformed into, for example, a JPEG (joint photographic experts group) image file (.jpg file) or a TIFF (tiled image format file) file (.tif file) and stored on the user's local hard drive or network.

If the merchant has properly scanned or previously stored documentation in support of the Inquiry, the merchant may select the “browse” option to review the stored image files (step 320). The “browse” option is suitably configured to launch access to an application such as, for example, WINDOWS EXPLORER® (step 330). If the merchant wishes to attach supporting scanned documentation, or any other type of documentation (e.g., word processing document) to the merchant response form, the merchant selects the desired files from the local hard drive or network and the application causes the selected files to attach to the form (step 340). The merchant may attach one or more document images to be uploaded or sent to server 100. The documents may relate to the same Inquiry/Chargeback, or they may relate to multiple Inquiries/Chargebacks.

The invention may also accept any comment or other remark from the merchant (step 345). In one embodiment, the merchant may indicate comments or provide markings on the electronic documents. Once satisfied with the documentation that has been located or scanned in, the merchant may select the “send” option (step 350). The program then verifies that all requested fields are complete (step 360). If field items are missing and/or contain invalid data (e.g., numeric data where alpha data is used), the program causes an error message to display (step 370). If all fields are complete, the program displays a message such as “Merchant Response Completed Successfully” (step 380) and transmits the completed form and attachments to the server for processing (step 390).

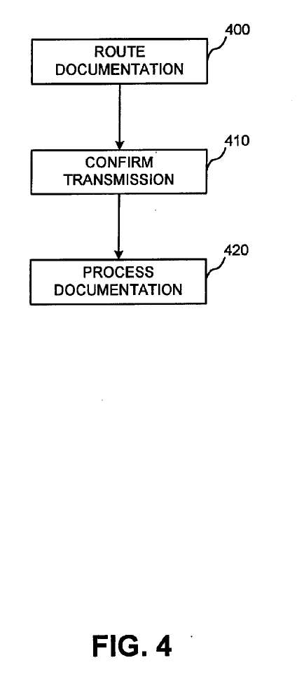

With reference to FIG. 4, the completed merchant response form and any attached documentation is routed to the computer server 100 for processing (step 400). The completed form and attached documentation are verified by the server to confirm that the transmission was successful (step 410). In accordance with one aspect of the present invention, server 100 may check the size of the received form and documentation to confirm the successful receipt of all data. Alternatively, server 100 may open the received form and attached documentation to confirm a successful transmission.

If the transmission was successful, the form and documentation are routed, via communication channel 190, to a computer for processing (step 420), such as backend processing computer 195. The uploaded documentation is scanned for viruses and the integrity of the uploaded files is confirmed. In addition, the uploaded documentation may be checked for a compatible dots-per-inch (dpi) resolution and for a compatible image type. Image types such as TIFF files, JPEG files, PDF files, or any other well-known image file format are supported. For additional information on supported graphics file formats, refer to “Graphics File Formats,” by David C. Kay and John R. Levine, published by Windcrest/McGraw Hill (1995), the contents of which are hereby incorporated by reference. The uploaded documentation is then associated with one or more specific post transaction disputes, such that the uploaded documentation can be easily retrieved. The association information may be stored in a database that is located in backend processing computer 195.

As previously disclosed, the present invention is conveniently described with reference to a transactional dispute between a merchant and an Acquirer, however, one skilled in the art will recognize that the scope of the present invention can include other end-users, such as, for example, administrative and financial personnel.

Data interchange may be based on a protocol such as XML (Extensible Markup Language) or a variety of other protocols such as XML, ASN.1, or the interchange protocol may be completely custom designed. The interchange may occur over a variety of network types in addition to TCP/IP. In one exemplary embodiment, transmission of document and form data outside the infrastructure may use specialized data interchange. Similarly, in alternative embodiments, submission and display of forms data may also use this specialized data interchange. In a particular embodiment, this data interchange may use Extensible Markup Language (XML) that is defined by an XML schema known to and agreed upon by the transmitting parties. XML provides the ability to create well-formed and valid representations of data that may be validated and exchanged between a variety of different systems. The specific interchange format of this data interchange of the present invention may be specified by either an XML Schema or Document Type Definition (DTD). This DTD or Schema identifies the exact data elements of the interchange, plus the grammar rules for when and where these elements may appear in the XML data that is exchanged according to the methods of the invention. An exemplary system of the invention may include software that performs processing of the XML data. For example, the software may perform inter-conversion of XML data to and from any of the data entry forms, data display forms, document-only transmissions, and infrastructure. XML permits a variety of systems from different vendors to communicate with one another without error. As such, the data interchange should also be resilient with respect to introduction of new data fields, and tolerance of data interchange based on both earlier and later versions of the interchange format. XML is also valuable in representing forms, e.g., dispute-related forms, as well as the data that may originate from those forms (during the process of user data entry). In one possible embodiment, XML can be digitally signed, providing auditability and leading to non-repudiation abilities for the exchange between the various parties (i.e., mechants, Issuers, Acquirers, and cardmembers).

In alternative embodiments, transmission of data is by any variety of communication mechanisms, protocols, formats, etc., which include, but are not limited to, remote procedure calls, local procedure calls, message queueing, message oriented middleware, database updates and stored procedures. Any of which might utilize any standard or proprietary technologies such as Java RMI, EDI, COM, DCOM, CORBA, IIOP, IBM MQ Series, MS MQ, etc.

When data is submitted to a host for processing, it may either include or omit the associated form. In both HTML and XML forms, the data elements may be identified by field labels and similar tags that are used variously for identifying data elements and rendering forms on a user interface. When included, the form and form data may be interspersed within the document, or may occur at completely separate locations within the document. Regardless of how the form data is sent to a host, forms may originate from locations that are the same or other than the hosts to which data is transmitted.

The location of the XML Schema, DTD, or other syntax definition (called simply “schema”) can vary according to the particular application. The schema may occur within the body of an XML message, or may reside on a specific host. The specific host where the schema resides may be identified by the XML message, or may simply be known by the communicating hosts to reside on a specific host. The host where the schema resides may be any of the communicating hosts in the architecture, or any arbitrary server such as one that is present on the Internet, and which serves as a repository for XML Schema. For example, a standard interchange format may be agreeable to all Acquirers and Issuers and as such, the format of this interchange may be defined by an XML Schema that resides on a central server on the Internet that stores standard XML Schemas used by financial business systems.

Forms and fields are described variously as part of the system and method for dispute handling. The present invention encompasses many variations of how these forms are represented and stored. They may be represented as HTML documents that are submitted to appropriate HTTP servers when the user of the web browser performs certain actions, such as clicking on buttons or depressing the “Enter” key. Forms may also be represented by XML documents that are rendered as HTML forms by software technology that operates on some machine such as a user workstation or web server. This processing may also occur in combination with another document or information such as would be captured in an XML Style Sheet (XSL). In one embodiment, the XML form document is sent from one server to another, then the second server processes the XML form along with an XSL document, and then this second server creates an HTML form in response to this processing, and finally sends this HTML form to the end user workstation. In another embodiment, a server sends an XML form to a workstation, which contains browser software that can read the XML form, download an appropriate XSL document, and then render the contents so that the user can perform data entry on the workstation.

Similar to the schema, the XML form and the XSL style sheet that is used in conjunction with the form can reside in a variety of locations. For example, XML forms may reside on a central server on the Internet that stores standard XML forms used by financial business systems. Alternatively, they could reside on the various hosts described for the architectures of the invention. Similar variation in the location of the form repository applies regardless of the protocol and format of the form document. For example, and HTML form could similarly be stored on a central server or any host of the architecture. Under other variations, the form could be embodied in a simple list of field names and/or data types, a spreadsheet document, as in Microsoft Excel, or a forms document, such as Adobe Acrobat, for example.

Information may be routed between the parties in a variety of manners, for instance, “store and forward” and/or “direct retrieval”. In a “direct retrieval” system embodiment, the user or system that is performing an activity initiates the retrieval of information that is needed to perform that activity. The information comprises some combination of forms, data, and documents.

In a “store and forward” system embodiment, the user or system that performs an activity may be automatically provided with information needed to perform that activity. The forms, data, and/or documents are transferred across the network from some server to the machine where the user performs work.

Note that both “direct retrieval” and “store and forward” may use any of a variety of software to perform transfers of files and data, and for the entry and collection of information. The workstation may run any combination of application software including but not limited to a mail client, web browser, and custom software. Email clients may utilize any of a number of email protocols such as POP3, IMAP4, or SMTP. Examples of emails clients are Outlook or Outlook Express by Microsoft Corporation of Redmond, Wash., or Netscape Messenger by Netscape Communications Corporation of Mountain View, Calif., or Eudora by University of Illinois and licensed to Qualcomm, Incorporated. Examples of the web browsers are Internet Explorer by Microsoft Corporation of Redmond, Wash. or Netscape Navigator by Netscape Communications Corporation of Mountain View, Calif.

Accordingly, users, such as merchants, may use the present invention to locate and transmit documentation in support of a pending dispute. To overcome the file transfer problem associated with initiating or responding to a dispute on an internal network or infrastructure, merchants can transmit documentation in support of a dispute process originating on an infrastructure with the speed and efficiency of the Internet. The present invention provides users a system and method for real-time transfer of supporting documentation with respect to a post transactional credit dispute. Documents such as ROC, hotel folio, and any additional duplicate transaction record which may facilitate the dispute process can be scanned, stored and retrieved as previously disclosed.

Having fully described the various embodiments of the dispute resolution system and methods of the invention, it should be recognized that other embodiments fall within the scope of the invention. For example, a dispute may be initiated by the cardmember to the Issuer or the Issuer to the Acquirer. The interactions between the parties may occur by virtue of a web client that interacts with a web server as part of an Issuer infrastructure. Alternatively, the cardmember may communicate with the Issuer by means of a telephone call or conventional letter to customer service during or after which the customer service representative uses an attached terminal to either interact with the Issuer infrastructure or the Issuer workstation. Analogous variations occur for the communication between the Acquirer and merchant.

The present invention is described herein in terms of functional block components and various processing steps. It should be appreciated that such functional blocks may be realized by any number of hardware components configured to perform the specified functions. For example, the present invention may employ various integrated circuit components, e.g., memory elements, digital signal processing elements, logic elements, look-up tables, and the like, which may carry out a variety of functions under the control of one or more microprocessors or other control devices. In addition, those skilled in the art will appreciate that the present invention may be practiced in conjunction with any number of data transmission protocols and that the system described herein is merely an exemplary application for the invention.

It should be appreciated that the particular implementations shown and described herein are illustrative of the invention and its best mode and are not intended to otherwise limit the scope of the present invention in any way. Indeed, for the sake of brevity, conventional techniques for signal processing, data transmission, signaling, and network control, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical communication system.

The present invention has been described above with reference to exemplary embodiments. However, those skilled in the art having read this disclosure will recognize that changes and modifications may be made to the exemplary embodiments without departing from the scope of the present invention. For example, similar forms may be added without departing from the spirit of the present invention. These and other changes or modifications are intended to be included within the scope of the present invention, as expressed in the following claims.

The detailed description of exemplary embodiments of the invention also makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description is presented for purposes of illustration only and not of limitation. For example, the steps recited in any of the method or process descriptions may be executed in any order and are not limited to the order presented.

1. A system for facilitating handling of a post-transactional credit dispute comprising:
a workstation capable of receiving commands from a user in response to an Inquiry associated with the post-transactional credit dispute;
a server in communication with said workstation;
a storage connected to said workstation, said storage having a plurality of documentation files stored thereon, said files having content that is relevant to the post-transactional credit dispute, said files capable of being transmitted from said workstation to said server;
a first communication channel coupling said workstation and said server;
a backend processing computer in communication with said server, wherein said backend processing computer is configured to process said transmitted documentation files; and
a second communication channel coupling said server and said backend processing computer, wherein said second communication channel is configured to transmit said documentation files from said server to said backend processing computer.

2. A method executed in a computer network for facilitating handling of documentation for a post-transactional dispute, the computer network having a server and a terminal, the method comprising the steps of:
(a) accepting, at said server, a User ID and password from a user at the terminal;
(b) displaying an Inquiry at the terminal, wherein said Inquiry is associated with said post-transactional dispute and said user is a party to said post-transactional dispute;
(c) locating said documentation associated with said Inquiry;
(d) transmitting said located documentation to said server;
(e) confirming receipt of said documentation at said server;
(f) associating said transmitted documentation with said post-transactional dispute; and
(g) storing said transmitted documentation and said association data for later retrieval.

3. The method of claim 2, wherein the post-transactional dispute is between a merchant and an Acquirer.

4. The method of claim 2, wherein the post-transactional dispute is between an Acquirer and an Issuer.

5. The method of claim 2 further comprising the steps of:
retrieving from said server a dispute handling form which coincides with said User ID;
displaying said form at said access terminal;
receiving data entered on said form at said access terminal; and
transmitting said form and said form data to said server.

6. The method of claim 2, further comprising repeating steps (a)-(g) until documentation for a plurality of Inquiries associated with said user has been located and transmitted to said server.

7. The method of claim 2 further comprising the steps of:
routing said documentation to a processing hub; and
confirming an integrity of said documentation.

8. The method of claim 2 further comprising the step of receiving, at said terminal, at least one scanned document in computer readable format, wherein said scanned document is associated with said Inquiry.

9. The method of claim 2, wherein said Inquiry is automatically initiated in response to a notification of said post-transactional dispute.

10. The method of claim 2, wherein said documentation comprises image files.

11. The method of claim 2, wherein said step of locating comprises locating said documentation associated with said Inquiry, wherein said documentation is stored on said terminal.

12. A computer-readable storage medium containing a set of instructions for a general purpose computer comprising:
(a) displaying an Inquiry at the computer, wherein said Inquiry is associated with a post-transactional dispute and a user of the computer is a party to said post-transactional dispute;
(b) locating one or more documentation associated with said Inquiry;
(c) transmitting said located documentation to a remote server;
(d) confirming receipt of said documentation at said remote server;
(e) associating said transmitted documentation with said post-transactional dispute; and
(f) storing said transmitted documentation and said association data for later retrieval.
